(19) United States
(12) Patent Application Publication
(10) Pub. No.: US 2003/0124494 A1
(43) Pub. Date: Jul. 3, 2003

(54) Tethys impact driven, earth shell expansion, paleozoic mesozoic boundary globe

(76) Inventor: William Thomas Kersey, North Chelmsford, MA (US)

Correspondence Address: WILLIAM T KERSEY, 2A WESTERN AVE, N CHELMSFORD, MA, 01863, US

(21) Appl. No.: 09/681,464

(22) Filed: Apr. 9, 2001

(51) Int. Cl. G09B 27/08

(52) U.S. Cl. 434/131

(57) ABSTRACT

Every current geophysical globe contains three main elements, which support the theory of Earth surface expansion; the ridge and rift systems of the spreading sea floors (new crust), the rafted continents of Pangea (old crust), and the folded and uplifted remains of the Tethys basin (K meteor crater). The patent sought is a globe of the smaller Paleozoic Earth around the time of the proposed Tethyian impact of K meteor including; Pangea and the Tethys basin (no Panthalassa Ocean) along with any method of displaying the expansion of the outer shell to current surface size. In specific the geometric expansion of the Earth;s shell above the remnant K meteor along suture lines (ridges) which maintain the geoid throughout time; as an example the stitches on a baseball. Further any method of displaying the penetration of K metoer remnant to depths under the Tethys basin as the driving force of expansion by conversion of rotational angular momentum from any orbital source into heat manifested at sea floor ridges as melting due to relief of overburden (no convection currents). Other claims include the correlation of K meteor and crater with Earth's magnetic field, gravity field, and seismic anomalies; the preferred path of magnetic reversal; East Pacific ridge system anomalies (antipode); and the centrality of K meteor remnant to Earth shell expansion and surface dynamics.

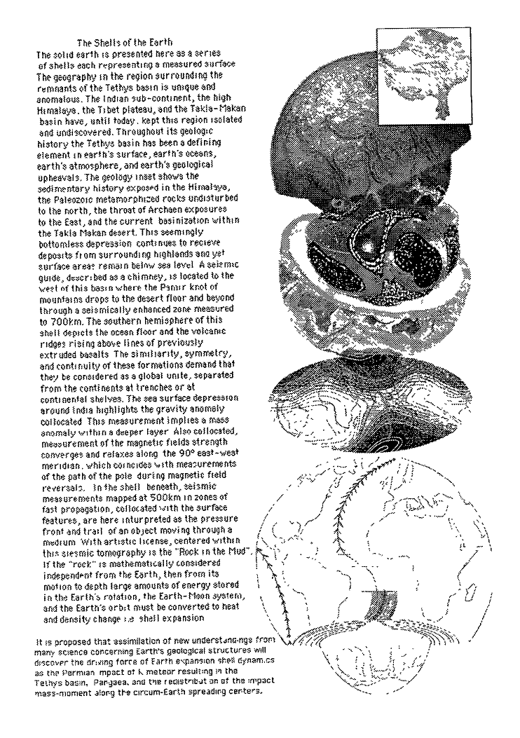

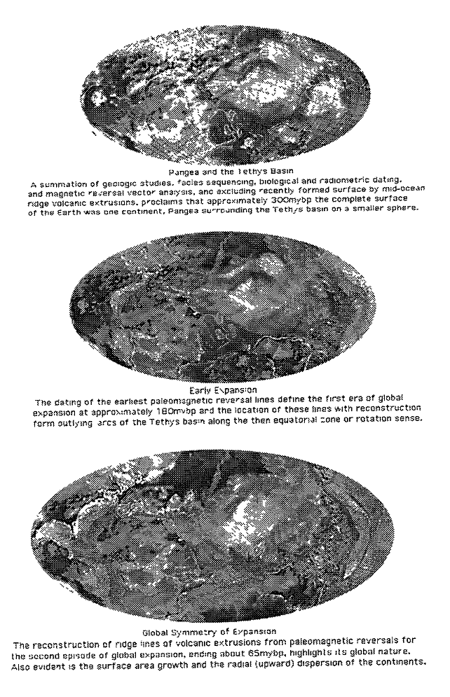

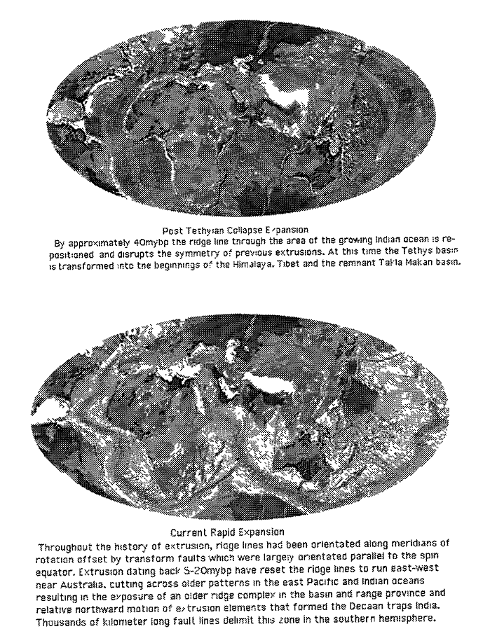

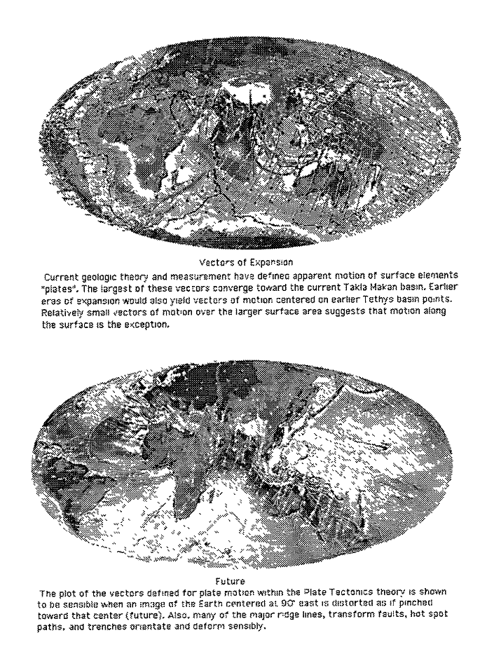

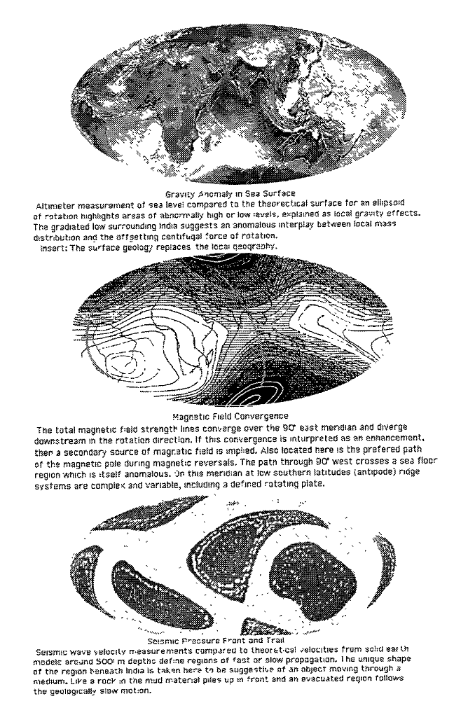

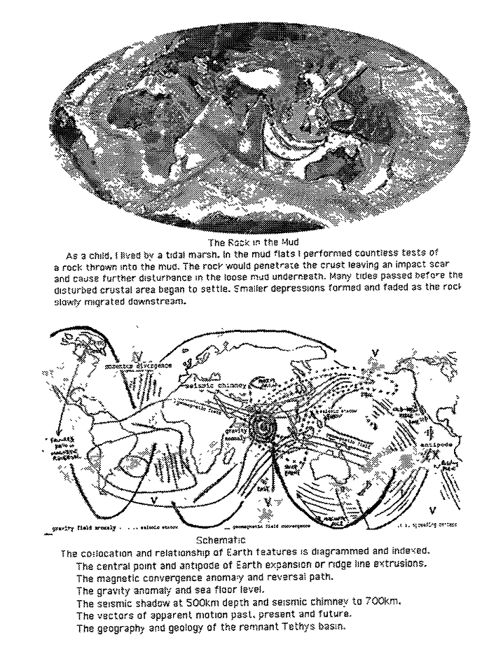

### BACKGROUND OF INVENTION

Introduction

As a child, I lived by a tidal marsh; the mud flats, of which, would make a strong analogy to the crust and mantle of the Earth. At low tide the exposed mud would dry out to form a crust and the more fluid mud, still saturated, had similarities with the current interpretation of the Earth's mantle. The mud crust floated on the loose mud sufficiently similar to the continents on convection currents of present theory to allow further analogy. In this media I performed countless tests of the result of an impact object with the mud crust and loose mud and occasionally hard mud (ice/rock) bottom. To these tests I ascribe my current belief that the Earth was impacted by a massive planetesimal ending the Carboniferous. My rock in mud impacts produced, almost invariably, a Pangaea-like disturbance. Pangaea of course, is the Permian mega-continent surrounding the Tethys bite. The rock would penetrate the crust, leaving an impact scar, and enter the mud underneath, causing further disturbance. The crust would be lifted around the hole of penetration in different amounts depending on the angle of impact and the shape and material of the object. The initial uplifted crust was separated from the undisturbed at its perimeter by faults. As time passed and the disturbed crust area began to settle back into its former position, secondary cracks would develop and these were generally concentric with the impact and the initial perimeter faults. Still later, although within seconds of impact, the disturbance of the lower layer would manifest itself with convection currents of loose mud to fill the perimeter faults, and to a lesser degree, fill the secondary faults with mantle material that set the old crust afloat. Again, the similarity with current theory is good. A greater degree of patience was needed to witness the culminating tendency of the mud flat to reclaim the surface area lost to penetration. Crust closest to the impact scar was forced radially in by the expanding loose mud. Smaller depressions formed and faded as the rock slowly moved downstream. Peripheral crust elements, corresponding to North and South America, could stall or move radially outward.

In 1968, while studying a topological Globe, I realized the correlation between the crust of the Earth and an impact scar in a state of normal decay. To prove my theory, I embarked on the independent study of major topics necessary to its confirmation.

It is proposed that assimilation of new understandings from many sciences concerning Earth's geological structures will discover the driving force of Earth expansion dynamics as the pre-Permian impact of K meteor resulting in the Tethys basin, Pangaea, and the redistribution of the impact mass moment along the circum-Earth spreading centers.

Dogma replaces dogma, but the truth is unique

Current Theory

The Earth moved under the feet of the established philosophical community, when Copernicus, Galileo, and Kepler altered the view of the solar system. It moved again when Wegner postulated that the continents are drifting. Once all-Earth (Pangaea) and now cleaved by the Atlantic Ocean, the opposite shores still display a jigsaw fit. Now scientists accept that continents move, but theories of the expanding Earth can not be allowed. Scientists first gathered to discredit Wegner's theory with irrefutable calculations based on “known” physical assumptions. While studies of rock sequence continuity and fossil record correlation within the polar continents of Laurasia and Gondwanaland and evolutionary divergence across the now impassable Atlantic abyss provided hard but interpretive evidence in support of “Continental Drift”, the old school refused to yield until coherent lines of alternating anomalous magnetism were measured and mapped by Vine et al across the Atlantic Ocean. These lineations were found to underlie all oceans and their symmetry defined a central line of apparent active volcanism. Explanations of the new measurements postulated that magma extruded at the central line of recent volcanism, which ridged above the mid-ocean slopes, cooled and locked in the magnetic alignment with the Earth's magnetic field. The alternating polarity of the magnetic lines suggested that the Earth's bipolar magnetic field had reversed. In fact had reversed many times as earlier lineations were formed. This implied the age of lineations would increase away from the ridge, which was supported later by deep sea drilling expeditions. The ocean depth of the reversals increased away from the ridge which is interpreted to be sinking of cooling material due to isostasy. Alternatively, it can be interpreted as tracks of the position near the then surface, of the suture line of extrusion which marks the current Earth expansion geometry (see text). The evidence of upwelling at the ridges and the theory of sinking of the over-dense material away from the ridges was associated with evidence of down trending slabs at Benioff zones beneath some continental margins to give rise to the convection cell hypothesis as the mechanism causing “continental drift”. Seismic wave detection above the deep sea trenches was interpreted to be deep earthquake waves guided along slabs of downwelling oceanic plates. Plates are defined as stable crust blocks that are added to at their ridge margins and destroyed at their trench margins (ignore the misuse of the word stable). Can the North American “plate” contain some of the oldest rock, Great Slave Lake schists, and one of the youngest Surtsey?

Some theories experience immediate disapproval while others enjoy immediate acceptance. Plate tectonics driven by mantle deep convection cells gained exclusive acceptance, although after years of calculation, modeling and measurement only a poor correlation to present day geotectonics can be claimed and most of the basic assumptions of the discipline are under scrutiny. How can the Atlantic convection cell exist with no downwelling limbs? Why has the upwelling remained so stable and symmetric? How can upwelling exist completely encircling Antarctica? Soundings near the ridgeline show a shallow source of magma and no extension to mantle depths, necessary to complete the cellular structure. Interpretation of trench slips mechanisms call for tensional faulting. The best convection models can not account for ridge systems and attempt to exclude them from forcing, relegating ridges to a passive roll of extension. Could the surface area lost into the trenches be exactly and immediately replaced at the ridges, to prevent any faulting between the echelons of reversals or distortion of the Earth's shape throughout geologic history ? If exact replacement is not maintained then the Earth would move under the feet of today's establishment, radially. Many times in the history of science old ideas become accepted when new observations are made. Even today some ideas that have been rejected, based on established scientific principles, await the technology that will provide the new measurements which will reestablish scientific principle and relieve objections. Although many of the barriers to acceptance may have fallen, some unifying event is often necessary, as the conversion of a respected scientist or the death of a long time opponent. Some ideas cross many disciplines and require a synthesis of independent proofs and some ideas need to be borrowed from other studies and applied to new topics. The following idea is an example of all of the above. About 300 mybp a large planetoid collided with the early Earth creating a large basin and embedding itself some hundreds of kilometers deep into the then crust of the Earth. The Earth was then a much smaller sphere whose total surface is now represented in the old continental crust. Geologist have long accepted the idea that all of today”s continents were once joined (Pangea) around a large sedimentary basin (Tethys). Further submitted is, that the impacting body, now located some 500 km below the southern tip of India is the continuing source of energy which drives Earth expansion and tectonics. The concept of the expanding Earth, as voiced by Carey and Heezen, is an idea who's time has come. Simply stated, the material extruded at the ridges adds to the surface of the Earth, expanding it by changing the density gradient of the Earth's layer currently above K meteor (see text). The loss of surface at the trenches and the loss of surface due to folding and faulting are of minor significance. Carey explains in detail to great to summarize here, as to how these losses are overestimated. With the failure of convection cell theories and with the evidence that ridge extrusions are a result of tensional forces which create a lifting of the overburden of pressurized rock and in situ melting, the expanding Earth concepts are shaking the foundations of geotectonics. Many difficult questions for convection cell theories are no longer proper questions. The plate concept is unnecessary now there are only two types of surface (crust): new surface due to expansion and some possibly old pre-expansion crust. The synchrony of ridge and trench is no longer essential. Antarctica can move radially away from it's surrounding spreading centers. The ridge system no longer needs to be linked to separate cells of thermal flow, but now can be viewed as one Earth wide event. The expanding Earth concept requires that the ridge systems be considered as parts of a whole. The sinusoidal North Atlantic ridge passes smoothly through the equatorial shift into the South Atlantic ridge. The South Atlantic ridge is presently sharply offset from the currently active Indian Ocean ridge by the South African fault zone, but tracing the Indian Ocean ridge activity backwards in time will lessen this offset as the Indian sub-continent backs away from Asia. Current theory holds that India was once connected to Antarctica and Africa. The Indian Ocean ridge can be followed a through loose junction at 90 east to the Australian ridge system and then tacross the confusing McQuarie fault and ridge spur to the South Pacific ridge. The Pacific ridge systems are different form those already mentioned in their rate of extrusion, their extent of expansion, and their weak symmetry of limbs. The East Pacific ridge system may have adjusted its ridge line position, which may account for the confusing magnetic lineations and topographical relief. First the ridge system stood further to the west producing symmetric magnetic anomalies reaching from the South Pacific island chains, to the South American continental shelf. Now the ridge has hopped to the East and its sinusoidal curvature is shifted 90 degrees to the previous expansion zone which has produced an area in the southeast Pacific, encircled by active volcanism. Recent side-scanning radar maps a rotating ‘plate’. I refe to this as the antipode, since it, the gravity center of the Earth, and the impact structures to depth are nearly coaxial. Asymmetry continues into the North Pacific ridge system where the Eastern limb, assumed missing by most, is now high and dry Western North America. The Cascade Range volcanics mark the now exposed ridge system which can be compared and connected with the Icelandic volcanics tentatively through the minor Arctic ridge system. It may be that the polar continent (Yukon-Siberia) is a hard crust to crack. Once around with a few imperfections, the suture line of expansion can be approximated by the circular surface shape similar to the stitches on a baseball. This shape has the unique property of allowing uniform expansion of the sphere. That is material equally added along this line is evenly distributed in the three dimensions. Material added along other lines, such as the equator, or any great circle, distort the sphere, in that case into an oval. The newest developments in other sciences provide data for further analysis. Planetology has been overwhelmed by the Voyager discoveries. Although the living laboratorys of the gas giants strongly support the long-standing accretion theory of solar system development, the moons of these developing systems display a wide spectrum of stages not yet understood. Of particular note, the moons Thethys, Mimas, and Miranda are observably in the process of absorbing a relatively large impacting body. The geodesic sciences currently define the Earth's shape. From the orbital eccentricities of numerous satellites and with localized surface measurements of gravity, the gravity field above the Earth is continually redefined. Interpretations are made about the materials and their distribution within the Earth, which are refined or supported by many other disciplines, such as geology, volcanology, petrology, deep Earth dynamics, and planetology. Along with these measurements and analogies a mathematical description of the dynamics of the spinning Earth has been developed. The ellipsoid that mathematically represents the Earth's mass distribution and rotational moment a is then compared to measurement to yield a contour map of variations. Countless minor variations in the equilibrium or potential surface can be defined and these can be used to locate subterranean structures, anything from salt domes to shock cones. A few major variations from the potential Earth surface become apparent and are explanation for large scale trends in surface adjustment, such as ice cap isostasy. One major gravity anomaly, centered beneath southern India, is explained as due to the unusually deep crust root supporting the high Tibet and Himalayan. The newest measurements of sea surface from satellite, also show a depressed sea level around the tip of India above this gravity anomaly. Earthquake studies are still at the phenomenological level. Individual quakes or swarms are assigned to known faults and associated by ‘recent’ historic geology. Some of the large-scale associations may not be well founded, such as the ‘Ring of Fire’. Seismic studies, however, have advanced due to the emergence of three dimensional analysis (tomography) of time of arrival and directional data from the world wide seismic network. Seismic tomography produces images of the propagation of seismic waves through selected layers of the deep Earth. The 500 km analysis shows the seismic shadow of an enhanced propagation zone. At the boundary of this shadow appear features similar to a shock wave and tail, implying motion against a flow field. Other measurements of the deep Earth, such as heat flow, also show anomalous regions which are being used to study the Earth's core and core mantle boundary. The relentless march of local geological analysis for resource exploitation has fostered a new view of continental formation. Areas of similar rock sequences (terranes) appear to have attached themselves to noticeably different structures en echelon to grow the existing continental blocks. Coupling these with the linear segments of the ridge system formation make it hard to see how the plate concept has any value. What super-glue could withstand the tensional forces necessary to drag plates down trenches and away from ridges against a vacuum which is then passively filled by magma? Geomagnetic lineations have been measured and mapped for decades, but recently the chronology of these lineations has been more extensively studied. An important new phenomena has been identified, the superchron. This is a time, in the order of tens of millions of years, in which the extrusions from ridge centers or other sources show no reversals. Following the concepts that the Earth's magnetic field reverses polarity and that extrusion rates are uniform, a few eras of Earth's recent history experienced no magnetic field reversals. One major superchron began about 300 mybp and lasted for approximately 60 my. Roughly corresponding to the formation and break up of Pangaea. Intense study of the time during the reversal process has isolated a preferred path for the poes as they reverse their polarity. Magnetic alignment of polarized magmas track the field from approximately co-axial and normal through degrees of eccentricity to equatorial and beyond to reversed. Many of these studies outline a path around the 90 degree meridian, through the Americas and the Indian Ocean. This path bisects today's anomalous dipolar magnetic field symmetrically through the two major geomagnetic anomalies (90E 23N, 90W 23S). No survey of current theory would be complete without somehow killing off the dinosaurs. Don't bother shouting that they are not dead but evolved into birds. Forget that many species of dinosaur became extinct well before the Cretaceous Tertiary boundary or that some evidence for dinosaurs after the bounday and much evidence for the uninterrupted sequence of other flora and fauna has been documented. Ignore the possibility that although Iridium is a rare Earth and more abundant in meteorites, it need not have been consolidated from its original nebula when it rained down on Earth. We search for a hole but we know that impact killed the dinosaurs. The current theory in paleontology, punctuated equilibrium, does not require catastrophic change. The nature of fossil record precludes the preservation of necessarily limited populations during early developmental stages or at the edge of extinction. Still the major eras of geologic time are separated by observable change. The Permian, for example closed the book on many environments and life forms and opened niches for new ones. There are many changes in the history of life, but only one discontinuity

Comparative Planetology

Early stages in the development of planet Earth can be compared to the stages of existing planets and moons through the recently gathered Voyager data. The well accepted accretion theory of planetary formation provides that planets have reached their current mass and mass distribution by accumulating impact masses. Satellite imaging has shown that the small moons of Saturn, Mimas and Thethys, represent a stage in planetary development when planetary bodies are larger than impacting bodies only by one or two orders of magnitude. Some even smaller moons of Saturn, the moons of Mars, or the multitude of interacting asteroids within the asteroid belt should provide examples of impacting bodies of nearly equal masses. The icy moons of Jupiter provide examples more readily comparable to the visible impact histories of the terrestrial planets and the Moon. The malleable icy surfaces of Europa, Ganeymeade, and Callisto are a laboratory for the study of the assimilation of impact masses and the redistribution of these mass anomalies as the forces of gravity and rotation work to restore the spherical resting shape of these moons. A commonly held belief that redistribution of impacting masses is accomplished by randomly distributed volcanics which result from internal and external stresses can find support in the study of the geologically active moon of Jupiter,lo or in extinct volcanic activity of Mars and the Moon, how ever redistribution of mass after impact may result in more uniform geologic activity. The geometric line of volcanics that define the spreading centers of the mid-ocean ridges in Earth's active geology represent redistribution of an impact mass anomaly. The driving force of ‘continental drift’ is the forces of gravity and rotation as they act to re-establish the rest ellipsoid. The mass anomaly central to this circle of redistribution is well established by gravimetric satellite measurements, by SEASAT sea level measurements and by ground based measurements of anomalies in the Earth's magnetic field. Also, the stages of development visible in Voyager images and mappings of the moons of Jupiter and Saturn have their counterpart in well-documented stages of Earth's geological record. The Tethys basin surrounded by Pangaea can compared be to the dominant impact crater of the moon Mimas. The planet wide redistribution patterns of the moon Tethys can be compared to the earth wide redistribution pattern of sea floor spreading. The very recent altimeter measurements of the surface of Mars showing terrain created and dominated by impact is an example of planet-wide disruption and redistribution. The Voyager space crafts have provided new evidence that necessitates rethinking about planetary development. The Solar Nebula theory can explain: A vast cloud of gas and dust from early generations of nuclear fussion reactors gone critical, with rare earth's to pepper the swirl of HHeCNOCaMgSiFe, Condensed by further Novae or under its own gravitation into a shrinking solar disk and shells of debris in stable orbits. Accretion, differentiation and resurfacing impacts for the rocky inner planets and for the moons of the outer giant gas systems. The meteorites confirm the theory. The Earth is still accreting. Tons of micrometeorites fall to Earth. The 26 million tear extinction cycle signifies continuing impact.

Crustal History

The research data for local rock sequences is immense, and not all is designed with a global view. Many geologists, however, have developed global views and a recent consensus would list these major stages in Earth evolution:

1. Major accretion 4 Hydrosphere 7 Pangaea/Tethys

2. Mantle/crust 5 Sedimentation 8 Continental drift

3. Atmosphere 6 Life/shells 9 Ice ages

The evidence for stage 8 has been amassed recently, but is among the best documented (Cox), (Pitman), (S. A. reprints). After studying this evidence and adding the concept of impact, I would tell the story of Earth history differently. The climate bands of the Carboniferous had etched their signature sedimentation heavily on proto Laurasia and Gondwanaland. These two circum-polar continents were separated by an equatorial ocean in which the development of shells further marked the equatorial region leaving traces that now trend NW-SE. As the Permian dawned, this scene had been largely transformed. Pangae now arched from pole to pole forming a circle of uplifted crust around the Tethys bite. New environs were produced causing the mass extinction of life that had adapted to previous niches, and allowing isolation of species that expanded rapidly into their new niches. The Carboniferous ended by impact. Isolated from Pangaea by a raised rim and ejecta blanket associated with impact the Tethys depression, whose Paleozoic metamorphosed basement had then been covered by Permian detritus deposits, produced a facies sequence unique to itself that now is exposed in the Himalayan thrust system documented by many studies. Also, remnants of the conglomerate boulder bed ejecta underlie the Tethyian deposits and unconformably rest on Paleozoic basement (Blaini-Talichir boulder beds). The final element of impact origin is the possibility of a central massif. Since none has been described on Earth, the true nature of a central massif is not known. My proposal is based on mud flat experiments which would, contrary to water droplet tests, show that the central massif consists of the exposed core of the impacting object. Initially at the central impact point, the central massif may migrate under the force of its unchecked linear and angular momentum. I have produced clay models of the elements of K crater as they now appear on the Earth's surface. Seismic measurements and detonations completed by Vesanen 76, et al locate a 700 km seismic chimney at a point where the Pamir Knot of cliffs drops to the Taklan Makan basin. In my models this chimney lags behind the central massif (Nangar Parbat) and may account for the secondary uplift and basinization in the area. K crater impact scar effected the hydrosphere, the biosphere, the lithosphere, and finally the athenosphere. Although delayed by a short 100 million years, the impacts effect on the mantle was manifested in crust expansion (Carey). In a series of drawings I have related the mid-oceanic ridge extrusions to the crater site. The paleomagnetic lines of the ridge system, described by Vine, and mapped by Pitman et al, and interpreted by Carey to be proof of crustal expansion, were used in the models to represent the redistribution of mass necessary to the incorporation of the impact mass to the pre-impact Earth. This is consistent with the expanding Earth concepts of Carey and does not depend on the resolution of trench system dynamics. The Earth models reverse the crust extension, first the most recent uplift and volcanic activity at the ridges and trenches eliminates much of the present geographic and topographic landmarks. Secondly, the continents close with a marked directional change 40 mybp to form Pangaea, the Tethys basin and the Eopacific (Carey) 80 mybp. Finally, the Pacific basin closes to leave a significantly smaller surface area dominated by K crater 300 mybp. In reading the work of Carey and authors quoted by him, I am astounded that so little research in this country has followed Carey's line of thought. The tensional character of the trench systems and the circum-antarctic spreading centers as described by Carey, displace the subduction theory and argue for the expansion of the Earth's crust. I am opposed to Carey's hypothesis that the North East ridge system is not symmetric and need not have a subducted eastern wing. I feel the Basin and Range province is the Eastern wing. The uniqueness of the geography of western China and Tibet is apparent on any topographical world map. The Himalayan mountains, as is commonly known contain the highest mountain peak, Everest 29028, and many of the nearly highest peaks, K2 28250. This range is known for its steepness, its extent and width and for its remoteness. Although situated between two of the most populated areas of the world, much of the Himalayas and the Tibet remains unknown. The Tarim basin north of Tibet is also unique and although in complete antithesis to the Himalayan uplands. The Tarim basin contains some of the lowest land points, the surface of the Turfan depression is 505 below sea level and the sedimentary basin beneath falls to unsounded depths. Further to the north lies Lake Baikal the worlds deepest lake −5315 ft. Small villages in the Altagh mountains are among the most remote in the world and are the most distant from the sea. Rare plants and animals highlight the area including the mythological Yeti. Even the mind of man has reached an uniqueness demonstrated by his folklore and religions The strangest place on Earth must be there The uniqueness of the geology of western China and Tibet is associated with the same structures listed above. The Himalayas are Strike-slip Mountains, lifting sedimentary sea beds up and over themselves as the stable Siberian volcanic craton and the unified volcanics of the Deccan plateau close the ancient Tethyian sea. These uplifted rocks provide the major evidence in defining a most unique time of Earth history, the time of Pangaea and the Tethys ocean. Yet north of the jumble of Tibet remains the vestigial Tethys dried of ocean influence and receiving only scree deposits from its ring of mountains. This truly can be called the great Asian anomaly. LANDSAT and GEOSAT satellite imagery has allowed modern geologist access to study the topology and geology of Western China, which has been isolated for many decades. Ground studies done previous to the political situation have categorized and summarized the major structures in and around the Tarim basin. The Tien Shan mountains, to the north and the Tagh mountains, to the south, form the boundaries of a region at which this article is based. The Taklan Makan desert occupies the entire Tarim basin from approximately 80 to 100 East longitude and 30 to 40 north. latitude. Geologists have uncovered little geologic structure within this basin and even acoustic soundings have failed to demonstrate any subsurface formations other than the accumulated layers of detritus and recent sedimentary deposit. These deposits have accumulated to great depths and are continually subsiding under their own weight, which allows for additions. In the Lop Nor depression seen clearly from Landsat the surface already below sea level shows centered faulting and sinking of rapid and continued action. It would seem that the present base of the mountains is only a refraction to the detritus' continued decent to unknown depths.

Impact

LANDSAT can document the geology of the wrinkled continents, and SEASAT can measure the swells and swales in the sea surface, and GEOSAT can map the gravity and magnetic anomalies, all in support of the tectonics theory of Earth's crustal evolution. Still suddenly Pangaea arches from pole to pole around the Tethys bite.

Our understanding of the Solar System has just been overhauled by the new flood of physical data resulting from U.S. space missions. All this new data has and will make a major impact. I feel that the most significant finding is that the terrestrial planets are littered with impact craters and debris. The Moon as viewed by Lunar orbiter; Mars photographed by Mariner 6,7, and 9; Mercury by Mariner 10; and Venus by radar showed a crustal history dominated by impact structures. If the Mare of the Moon and the Planitia of Mercury, and Mars are also attributed to impact, then the common crustal history of the inner planets is largely that of impacts. Voyager 1 and 11 have added the moons of Jupiter, Saturn, and Uranus. This fact follows from the prevailing theory that the planets accreted through collection of planetesimals. The cratered crust would then be the record of recent accumulation. The most recent, of course, are the least disturbed. How much of the Earth's surface is newly accreted? How much of kindred Moon's surface is newly accreted? Did the Apollo astronauts sample unaltered, ancient Moon or recent arrivals? The Moon shows its plumb bob face to the gravity well of Earth. Positive gravity anomalies create basins. Are the mare of the Moon “upwellings” or deposits of the constant particle rain? Even Mariner dug in debris. Could this be impact? YES. The other inner planets are littered with impacts. The Argyre Planitia of Mars may link to Valles Marineris and Olympus Mons. The Aphrodite Terra which dominates Pioneer Orbiter radar images of Venus shows impact structures possibly linked to resurfacing volcanics. Lakshmi planumon Venus appears to me to be a rock in the mud. The ice covered moons of Jupiter also show planet wide redistribution patterns. Voyager has revealed ongoing experiments in planetesimal accretion in the icy moons of Saturn. How will Mimas absorb that relatively large impacting object? Will it fracture concentric to the impact site as Tethys is doing? Or will the smaller body lose its identity, warp and distort into regions of chaotic terrain as possibly seen in the moon of Uranus, Miranda? How do objects of low relative velocities, such as two asteroids in the asteroid belt, collide and coalesce? W. K. Hartmann in “Cratering in the Solar System” fully discusses the common crustal history and points out that the population of asteroids continue to crater inner planet crusts. I feel Hartmann's inventories of planetesimals: 1, asteroids, 2, craters, 3, obliquities, and 4, second order planetesimals, are central to an understanding of the growth and present of the inner planets.

If the second largest planetesimal in the orbital region of the Earth developed at the expense of the early Earth, it is presumed that it too would now show a cratered crust. Other minor crustal structures might parallel the super-volcano or equatorial fractures of Mars. Altough most scientists, pointing to the oldest rocks found on Earth, would imply that the early impact history of the crust has been obliterated, A. M. Goodwin of the Precambrian Research Group has catalogued structures resembling those of impact. His map of distribution of craton-like impact structures clearly affirms that the impact history of Earth has not vanished. A cataloque of smaller and more recent meteorite craters is compiled by the Meteoritical Society. A list to which many authors would ascribe other crater structures.

Dachille, in his report on the ISHIM basin remarks that mare-forming impacts are not restricted to early eons. His graph of geologic time vs.

mass and crater diameter supports the belief that catastrophic impacts are probable. Likely, in fact, due to the immense time of trial in which such an event could happen. The new wave of catastrophe theory in statistics can also be applied to geology.

The recent investigations of the terrestrial planets coupled with the advancements in the interpretations of Earth impact structures can be seen to show that the Earth is indeed a terrestrial planet with its common and continuing impact history.

An impartial observor of our inner Solar system, that is one who is egocentric but not terra-centric, would attempt to extend the cratered history of the inner planets to apply to the current surface of the Earth.

The circularity of the Hudson Bay Basin, or in the mouth of the St. Lawrence, or the Siberian craton, or perhaps the polygonal craton basins that are the basis of the continents could all be of impact origin. The uplifted rim and depressed basin of the Taklan Makan desert in western China would be central to any report that observor might make. From space the Earth has one obvious impact scar. The lack of recognition of this structure has left it nameless.

In this text, I will use the name K crater to apply to the impact scar whose distorted shape remains identifiable.

An astrobleme on the inner planets is easily recognized by its, near circular metamophized depression, uplifted rim and ejecta blanket, and possible central massif. The reconstruction of Pangaea and the Tethys basin, in the next section, would bring all these elements now present in Asian structures back into alignment.

The Earth's Shape

The overall expansion of the crust by addition at the ridge sites is consistent with the incorporation of the impact mass into the Geoid by redistribution. A two body surface, that is the instantaneous total surface of two impacting bodies, would also be consistent with ridge expansion. The mathematical implications of a two-body system include the postulation of a suture line similar to the stitches on a baseball. It is clear, however, that this impact would affect all Earth parameters and unless damped these effects should be visible. Adapted from Rapp 74/Mekenzie, the gravimetric isobars clearly show the uniqueness of the East-Asian anomaly. This anomaly also appears in recent ocean level mappings, and in geomagnetic isobars leading Raspopov to separate out the measurements over the East-Asian anomaly from the uniform magnetization of the Earth. Recently seismic imaging of the 500 km deep Earth shell highlights one major anomaly beneath the equatorial Indian Ocean. Within the remarkable detail I can see a shock front and a shadow tail, implying that a remnant of K meteor penetrates the Earth's density gradient and rotational momenta. These measurements are of course in the present. They do have a past and one that is in common with the ridge system expansion, Himalayan-alpine orogenisis and rotational and orbital dynamics. The obliquity and orbital eccentricities in Earth history are also consisteny with Permian impact. In fact I can find no geologic or planetologic data that will refute the existence of K crater. Put simply, two large bodies of time-fluid material coalesce, first by impact distortion of the smaller body onto the larger, then by redistribution of mass within the two body system along geometric sutures, and finally either quiescent old age expanded spherocity or catastrophic dis-association. The energy needed to move rock around comes from the transfer of angular momentum from the dense impacting object to the layers of the Earth above the current depth of that object. As in my mud flat experiments, the impacting object remains identifiable, even from the surface, as it slowly sinks toward a depth of equilibrium. The object spinning with the Earth gives up angular momentum as it gets closer to the center of gravity. This creates a relative motion between the sinking object and layers above, in that the object would appear to move against the spin of the Earth. This can be seen in the relation of current and past surface structures to the position of the seismic chimney, and the gravity and magnetic anomalies described above. Importantly, I can see this relative motion in the seismic tomography of deep structures where a shock front faces the Earth's rotation and a penetration trail marks the wake. The angular momentum thus released energizes Earth layers above. With greater energy, greater heat, greater momenta to resist the pull of gravity, comes the loosening of the previous Earth's density gradient, and expansion. Large cones of Earth can move as one, absorbing momenta without changing their internal density gradient, but some lines aremathematically defined and designed to have all mass sections moving away. These zones experience enormous relief of overburden pressure and respond by rapidly changing their density gradient i.e. melting. Once defined these rifts would have a long lifetime, but always be re-positioned by the then existing dynamics of the whole Earth system. (conversation with Dr. Geoff Crowley John Hopkins Laboratory). The reshaping of the Earth into a much larger object is temporary, the final shape has yet to be determined.

[New Section Title]

### DETAILED DESCRIPTION

A model Paleozoic Mesozoic boundary Earth globe displaying Pangea, and the Tethys basin as the entire surface of a sphere of an appropriately smaller diameter than a sphere representing today's expanded surface. The Tethys basin shall be presented as the impact crater of K meteor. The imaginary Panthalassa shall not be represented. The outer shell of the Paleozoic sphere shall expand to current size and shape. The expanding shell is defined by the forces acting to absorb K meteor into the current Geoid as the Earth material disturbed by the impact of K meteor and the resulting imbalances in orbital and rotational dynamics. The expansion shall proceed in time sequence and along the geometric line defined by the sea floor ridge systems and be approximated by the “stitches on a baseball”. Annotation will highlight the central location of K meteor remnant in respect to three concentric episodes of expansion delimited by sea floor paleomagnetic reversal lines, and currently defined “plate” tectonics motion vectors. Visualized or annotated will be Earth's gravity field anomaly, Earth's magnetic field anomaly, and Earth's seismic tomography anomaly that identify K meteor remnant as a rock in the mud. Also annotated are the Pamir Tarim seismic chimney and the K meteor impact antipode with their relation to K meteor remnant.

1. The similarity of K meteor crater to the geologic structure the Tethys basin.

2. The centrality of K meteor remnant to sea floor spreading.

3. K meteor as the explanation of collocated anomalies in Earth's gravity field, magnetic field and seismic tomaogrphic measurement.

4. K meteor remnant as the driving force of Earth shell expansion or “plate tectonics”.

5. The titles K meteor, K meteor crater, and K meteor remnant.
